(19) United States
(12) Patent Application Publication
(10) Pub. No.: US 2017/0140323 A1
(43) Pub. Date: May 18, 2017

(54) FACILITATING COMMUNICATION SESSIONS BETWEEN CONSUMERS AND SERVICE PROVIDERS

(71) Applicant: HomeAdvisor, Inc., Golden, CO (US)

(72) Inventors: John Casey Laird, Lakewood, CO (US); David Paul Zeckser, Denver, CO (US); William Brandon Ridenour, Denver, CO (US); Craig Smith, Denver, CO (US); Andrew Tiley, Denver, CO (US)

(21) Appl. No.: 14/942,829

(22) Filed: Nov. 16, 2015

(51) Int. Cl. G06Q 10/06; G06Q 30/00; H04L 29/08

(52) U.S. Cl. CPC G06Q 10/063112; H04L 67/322; H04L 67/141; H04L 67/02; G06Q 30/016

(57) ABSTRACT

Disclosed herein is a method and system for facilitating communication sessions between a service provider and a consumer. More specifically, the embodiments described herein are directed to receiving, from a consumer, a request for a product or service. The request is analyzed to determine one or more service providers that perform or provide the requested product or service. When various service providers are identified, an algorithm ranks the service providers from high to low. The highest ranked service provider is provided with an opportunity to instantly begin a communication with the consumer. If the highest ranked service provider declines, the next highest service provider is given the opportunity.

### FIELD

The described embodiments relate generally to facilitating communication sessions between a consumer and a service provider such as, for example, a home service provider, a contractor and the like. More specifically, the described embodiments are directed to enabling a service provider to “instantly connect” with a consumer in a communication session upon the service provider receiving an inquiry about a particular project, product or service.

### BACKGROUND

There are many service providers that are willing to provide their services to consumers. Likewise, there are many consumers that are looking for various services and/or products provided by various service providers. However, it may be difficult for consumers to identify reliable and trustworthy service providers. Likewise, it may be difficult for service providers to find and contact consumers that have jobs and projects that the service providers are qualified for and are interested in pursuing.

### SUMMARY

Disclosed is a method for facilitating a communication session between a consumer and a service provider. According to this method, an inquiry about a particular project, product or service is received from a consumer. The inquiry is parsed to determine one or more items of information about the particular product or service. Using the information, a plurality of service providers that perform or otherwise provide the identified project, product or service are identified. A subset of service providers are selected from the identified service providers. In some implementations, the subset of service providers are identified using a scoring algorithm. The subset of service providers are then ranked based on the scores generated from the scoring algorithm. When the highest ranked service provider is identified, a communication session may be automatically initiated between the highest ranked service provider and the consumer.

A system for facilitating communication sessions between consumers and service providers is also disclosed. The system includes at least one processor and a memory coupled to the at least one processor. The memory stores instructions that are executed by the at least one processor. The system facilitates communication sessions between a consumer and a service provider. More specifically, the system provides a service request form to a consumer. The consumer uses the service request form to provide information about a desired project, product or service. The request form is parsed or otherwise analyzed to determine one or more items of information about the project, product or service. Using this information, a plurality of service providers are selected or identified from a database of service providers. The service providers are then ranked using a scoring algorithm. Each ranked service provider, from the highest ranked service provider to the lowest ranked service provider, may be given an opportunity to establish a communication session with the consumer.

Also disclosed is a computer-readable storage medium encoding computer-readable instructions which, when executed by a processor, performs a method for facilitating a communication session between a consumer and a service provider. According to this method, an electronic inquiry about a project, product or service is received from a consumer. The inquiry is analyzed to determine one or more items of information about the requested product or service. Using the information, a plurality of service providers that provide the product or service are identified. The service providers are then pared down to create a subset of service providers. The subset of service providers are identified based, at least in part, on a historical acceptance of one or more solicited communication sessions. The subset of service providers are then ranked based, at least in part, on the historical acceptance of the one or more solicited communication sessions. An automated message is then provided to a highest ranked service provider in the subset of service providers. Depending on whether the highest ranked service provider accepts or rejects the automated message, the automated message may be subsequently sent to the next highest ranked service provider.

### BRIEF DESCRIPTION OF THE DRAWINGS

The disclosure will be readily understood by the following detailed description in conjunction with the accompanying drawings, wherein like reference numerals designate like structural elements, and in which:

FIG. 1 shows an example system that may be used to facilitate one or more communication sessions between consumers and service providers according to one or more embodiments of the present disclosure;

FIG. 2 illustrates example components or modules of a communication module that may be used to facilitate one or more communication sessions between consumers and service providers according to one or more embodiments of the present disclosure;

FIG. 3 illustrates a method for facilitating communication sessions between consumers and service providers according to one or more embodiments of the present disclosure;

FIG. 4A illustrates an example user-interface that may be used to facilitate one or more communications sessions between consumers and service providers according to one or more embodiments of the present disclosure;

FIG. 4B illustrates the example user-interface of FIG. 4A provided on a portable computing device according to one or more embodiments of the present disclosure;

FIG. 5A illustrates a second example user-interface that may be used to facilitate one or more communications sessions between consumers and service providers according to one or more embodiments of the present disclosure;

FIG. 5B illustrates the example user-interface of FIG. 5A provided on a portable computing device according to one or more embodiments of the present disclosure;

FIG. 6A illustrates a third example user-interface that may be used to facilitate one or more communications sessions between consumers and service providers according to one or more embodiments of the present disclosure;

FIG. 6B illustrates the example user-interface of FIG. 6A provided on a portable computing device according to one or more embodiments of the present disclosure;

FIG. 7A illustrates a fourth example user-interface that may be used to facilitate one or more communications sessions between consumers and service providers according to one or more embodiments of the present disclosure;

FIG. 7B illustrates the example user-interface of FIG. 7A provided on a portable computing device according to one or more embodiments of the present disclosure; and

FIG. 8 illustrates example components of a computing device according to one or more embodiments of the present disclosure.

### DETAILED DESCRIPTION

Reference will now be made in detail to representative embodiments illustrated in the accompanying drawings. It should be understood that the following descriptions are not intended to limit the embodiments to one preferred embodiment. To the contrary, it is intended to cover alternatives, modifications, and equivalents as can be included within the spirit and scope of the described embodiments as defined by the appended claims.

Disclosed herein is a method and system for facilitating communication sessions between consumers and service providers. As used herein, the phrase “service provider” may include individuals who offer a product, a service, or a combination of products and services. In one non-limiting example, a service provider may be any individual or entity that performs or provides home service projects such as, for example, a contractor, a subcontractor, an interior designer, an architect, a plumber, a carpenter or other individual or entity that may assist with or otherwise perform a home improvement project. In other implementations, a service provider may include an individual or entity that performs one or more professional services, such as, for example, a tutor, a music instructor, a photographer, an attorney, an accountant, a repair person and the like.

As will be described herein, the systems and methods disclosed enable a consumer to identify service providers that perform or provide a project, product or service the consumer is interested in. More specifically, the system and methods described enable a consumer to electronically request and/or provide information about a particular project, product or service that is typically provided by service providers. For example, the consumer may access a website, an application (e.g., on a smart phone, tablet computer and the like) and provide information about a particular service or home improvement project the consumer is interested in. This information may include a desired type of materials, desired brands of products, scope of the project and so on. The information is then provided to a computing device which processes the information and identifies one or more service providers that can perform the desired task. The identified service providers are then ranked using a scoring algorithm and/or on a number of other factors. Some of these factors include, but are not limited to, past response times, acceptance of solicited communication sessions (e.g., the number of times previous leads were accepted and whether the service provider communicated with the consumer), acceptance of automated messages, quality of work, availability, reviews from previous jobs and so on.

Once the service providers are identified and ranked, the system automatically generates an automated message and provides it to the highest ranked service provider. As used herein, the phrase “automated message” includes, but is not limited to, a voice communication (e.g., a phone call), a video communication, a Short Message Service (SMS) message, a Multimedia Messaging Service (MMS) message, a text message, an audio message, an email or other such electronic communication.

The automated message may include information from the consumer. More specifically, the automated message may include information regarding the geographic location of the consumer or the project, the type of project the consumer is interested in, a proposed budget for the project, a timeframe for completion of the project and so on.

Once the automated message is received, the service provider can choose to “instantly connect” with the consumer. As used herein, the phrase “instantly connect” or “instant connect” means that the service provider and the consumer are able to directly communication with each other using a communication session facilitated by the system. This includes, but is not limited to, a service provider choosing to directly communicate with the consumer upon the service provider receiving the automated message, the consumer accepting or otherwise joining the initiated communication session, and/or the consumer acknowledging or otherwise accepting an automated message to directly communicate with the service provider.

In some embodiments, the communication session may be established using a voice communication (e.g., a telephone call), a video communication, an email, a MMS message, a SMS message, a text message, an instant message, or other form of electronic communication. If the service provider opts to communicate with the consumer, the system facilitates the communication session by connecting the consumer with the service provider.

However, if the highest ranked service provider declines to be instantly connected with the consumer, the system sends the automated message to the next highest ranked service provider that was identified. This process may repeat until there are no service providers left in the subset of service providers or until a service provider has agreed to instantly connect with the consumer.

In some implementations, the consumer may be given an option to accept or reject the communication session with the selected service provider. In another implementation, the consumer may view information about the selected service provider prior to accepting or joining the communication session. In yet another implementation, an automated message may be provided to the consumer prior to the system facilitating the communication session.

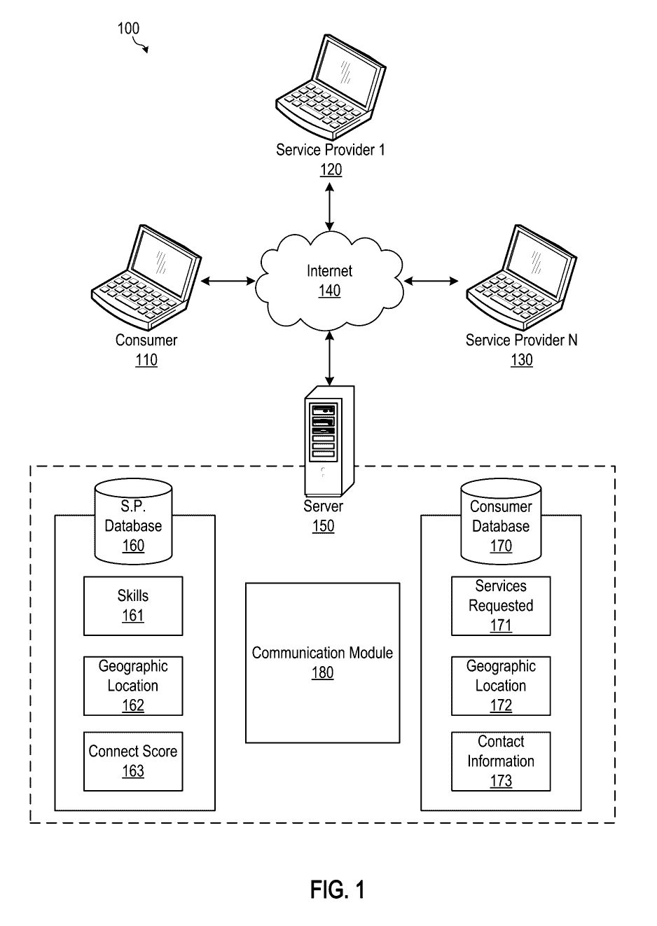

FIG. 1 shows an example system 100 that may be used to facilitate one or more communication sessions between consumers and service providers according to one or more embodiments of the present disclosure. For example and as shown in FIG. 1, a Consumer 110 may access the internet 140 using a computing device, navigate to a particular website and inquire about a desired product or service. The computing device utilized by the Consumer 110 may include a mobile phone, a tablet computer, a laptop computer, a personal digital assistant or other such device that is capable of accessing the internet 140.

Once the website is accessed, the Consumer 110 may inquire, select or otherwise provide information about the product or service they are interested in. For example, the Consumer 110 may be interested in a home remodeling project. Once the particular project is selected, the Consumer 110 may fill out an online service request form to provide additional information about the remodeling project. This information may include the room that is to be remodeled, a timeframe for the project, a projected budget, desired materials, a desired brand of a particular product, a timeline for the project, a geographic location for the project, contact information for the Consumer 110 and so on. Although a service request form is specifically mentioned, such a form is not required. That is, the Consumer 110 may access the website, an application or other electronic medium to provide information about the desired project or service.

The Consumer 110 may also be prompted to provide or otherwise submit personal information to a server 150. This information may include a geographic location of the Consumer 110, contact information for the Consumer 110 and so on. The information provided by the Consumer 110 may be stored in a consumer database 170.

The consumer database 170 may be hosted by or be otherwise accessible by the server 150. As shown in FIG. 1, the consumer database 170 may include the information discussed above. For example, the consumer database 170 may include services requested 171 (e.g., the type of products or services the Consumer 110 inquired about), the geographic location 172 of the Consumer 110 as well as contact information 173 of the Consumer 110. Although specific information is discussed, additional (or less) information about the Consumer 110 may be stored by consumer database 170.

The system 100 may also allow one or more service providers to access the website via the internet 140 and provide information about their respective products or services. This information may be stored in a service provider database 160.

For example, Service Provider 1 120 and Service Provider N 130 may access the website hosted by the server 150 and provide information about their skills 161 (e.g., the types of products, services or projects offered), the types of materials they work with, vendor relationships, and the geographic location they service or are otherwise associated with.

As will be discussed in greater detail below, the service provider database 160 may also store a connect score 163 about or otherwise associated with each service provider. The connect score 163 is determined by a scoring algorithm that tracks historical acceptance of leads by the service providers as well as the number of times the service providers have instantly connected with consumers. Thus, the more leads that have been accepted, the better the connect score 163.

More specifically, the scoring algorithm determines a probability of whether a particular service provider will answer an incoming communication relating to a particular product or service. In some embodiments, the connect score 163 of a particular service provider may be combined other variables to generate an overall connection probability of a received request. These variables may include time of day, day of the week, month of the year and so on. If the probability exceeds the threshold, the service provider may be contacted to be instantly connected to the consumer.

Although two service providers are shown and discussed, the system 100 allows any number of service providers to access the website and provide information about their skills and services. Likewise, any number of consumers may access the system to inquire about a variety of products, projects or services.

In addition, and although a website is specifically mentioned, embodiments of the present disclosure are not limited to websites or webpages. For example, the Consumer 110 may access an application on a mobile phone, tablet computer and the like and submit a request for information about a particular product or service. Likewise, the service providers may access an application on a mobile phone, tablet computer and the like and provide or update information about the products and services offered. In another implementation, the Consumer 110 may be instantly connected to a service provider using voice recognition technology. For example, the Consumer 110 may audibly speak (or otherwise input) the request and provide other identifying information about the request to an electronic device. The electronic device may parse this information and subsequently instantly connect the Consumer 110 to a service provider in the manner described herein.

In some embodiments, once the Consumer 110 has inquired about a particular product or service, a communication module 180 is configured to instantly connect a service provider with the consumer. More specifically, the communication module 180 may receive the geographic location information and the service request information from the inquiry made by the Consumer 110. The communication module 180 then compares this information to the information provided by the service providers.

More specifically, the communication module 180 matches consumers with service providers that can actually perform the requested tasks. That is, the communication module 180 determines the services requested 171 information from the consumer as well as the geographic location 172 information provided by the consumer and matches that information with the skills 161 information and the geographic location 162 information of the various service providers. Using this information, the communication module 180 determines a subset of service providers that may be a match or are otherwise likely to accept the lead (e.g., the project, product or service desired by the consumer).

Once the subset of service providers has been identified, the communication module 180 analyzes the connect score 163 of each service provider in the set. Each service provider is then ranked based, at least in part, on their connect score 163. That is, the service provider with the highest connect score 163 may be ranked first, the service provider with the second highest connect score 163 may be ranked second and so on.

When the service providers in the subset have been ranked according to their connect score 163, the communication module 180 automatically generates an automated message. The automated message may include information about the requested project, product or service. For example, the automated message may include some or all of the information provided by the consumer including, the type of product, project or service, the desired budget, desired materials, desired timeline for completion of the project and so on. When the automated message is generated, the communication module 180 sends the automated message to the service provider with the highest connect score 163.

The automated message may include information about the requested product or service from the consumer. For example, the automated message may include information about the type of product or service the consumer is interested in, the timeframe for which the project is to be started and/or completed, an anticipated budget for the project, product or service and so on.

When the automated message is received, the service provider may listen to, read or otherwise become aware of the information contained in the automated message. The service provider may then choose to instantly connect with the consumer. Alternatively, the service provider may reject the opportunity to instantly connect with the consumer.

If the service provider chooses to instantly connect with the consumer, the communication module 180 may (optionally) generate a second automated message and provide the second automated message to the consumer. The second automated message may include information about the service provider. This information may include the name of the service provider, the number of project the service provider has completed or provided to other consumers, consumer reviews of the service provider and so on. The second automated message may also give the consumer an option to instantly connect with the service provider.

If the consumer chooses to instantly connect with the service provider, the communication module 180 establishes a communication session between the consumer and the service provider.

In a more specific example, once the top ranked service provider has been identified, the communication module 180 may generate and provide a first automated message to the service provider via a telephone call. When the service provider answers the telephone call, the service provider may listen to the automated message and make a selection as to whether the service provider would like to be instantly connected to the consumer.

For example, the service provider may dial a “1” to be instantly connected to the consumer or the service provider may dial a “2” to decline the lead. Although specific input is described above, the service provider may be able to accept or decline the lead using any number of input or selection mechanisms.

If the service provider accepts the lead, the service provider may be placed on hold and the communication module 180 may contact the consumer to establish the communication session. For example, the communication module 180 may initiate a phone call with the consumer. When the consumer answers the call, the communication module 180 connects the consumer and the service provider. In some embodiments, the communication module 180 may relay information to the consumer that the consumer is going to speak with a service provider prior to the communication session being established between the parties.

In another embodiment, and as briefly described above, the communication module 180 may generate a second automated message and send it to the requesting consumer prior to initiating the communication session. For example, the communication module 180 may initiate a telephone call to the consumer. When the consumer answers the telephone call, the communication module 180 provides the second automated message to the consumer. The consumer may be given an option to instantly connect with the service provider or decline to join the communication session in a similar manner as described above.

If the consumer chooses to instantly connect with the service provider, the communication module 180 initiates a communication session for the parties. For example, the communication module 180 instantly connects the service provider with the consumer by joining the two telephone calls. Although a telephone call is specifically mentioned, other forms of communication are contemplated such as described above.

If the service provider with the highest connect score 163 declines the lead or does not answer or otherwise acknowledge the automated message, the communication module 180 may provide the automated message to the service provider with the next highest connect score 163 and the process described above repeats. That is, the service provider with the next highest connect score 163 receives an automated message and is given the opportunity to accept or deny the lead.

This process continues until the lead is accepted or there are no more service providers in the subset of service providers. If the latter occurs, a second subset of service providers may be identified by the system 100 and the process described above may repeat. In alternative embodiments, the system 100 may refer the requesting consumer to additional service providers using a different medium (e.g., the system 100 may provide additional service providers to the consumer on the website on which the original inquiry was made).

As described above, the connect score 163 may be calculated using a scoring algorithm that considers historical acceptance of one or more solicited communication sessions (e.g., the number of times a particular service provider has been matched with a potential consumer or lead versus the number of times the particular service provider has accepted an inquiry or has otherwise been instantly connected with the consumer). The connect score 163 may be calculated or otherwise stored for each service provider that is eligible for a particular requested service. Thus, the more times a particular service provider is instantly connected with a consumer, the higher the connect score 163 may be.

More specifically, the connect score 163 may be a probability of whether the service provider will answer an incoming communication. In some implementations, the probability is a weighted average of: 1) the historical acceptance rate of one or more solicited communication sessions by a particular service provider and 2) a historical global acceptance rate. The historical global acceptance rate may be all, or a particular subset of, acceptance of instant connect opportunities provided to all service providers, or a subset of service providers (e.g., service providers in a particular geographic region, having a particular skill set and so on), over a particular period (e.g., 14 days, 1 month, 1 year etc.).

In some embodiments, the weighting of the probability is based, at least in part, on the amount of history (e.g., the number of opportunities the service provider has had to be instantly connected with a consumer) of the service provider. For example, if the service provider has a long history, the weighted probability may be close to their historical acceptance rate. On the other hand, if the service provider does not have a long history, the weighted probability may be closer to the global acceptance rate.

Once the probability for the connect score 163 is determined, the probability may be combined with a hunger score that is associated with the particular service provider. In some embodiments, the hunger score is a combination of parameters that relate to the availability of the service provider to accept a lead. In some embodiments, the hunger score may also include an amount of money, such as a spend target or other such consideration, the particular service provider has expended or is willing to expend to be considered for leads.

For example, the service provider may be willing to spend a particular amount of money over a given time period in order to be considered for leads. More specifically, the service provider may select a particular spend target over the particular time period. Over the course of this time period, amount of money in the spend target may decrease as the service provider is provided leads. The amount of money left in the spend target is equivalent to the hunger score. For example, if a first service provider has a spend target of $1000.00 but has used $950.00, the first service provider would have a first hunger score (although the first hunger score may have been greater when the first service provider had used only $500.00 versus the $950.00 in this example. Thus, a hunger score for a particular service provider may change over the particular time period). However, if a second service provider has a spend target of $500.00 but has not used any of the money in the spend target, the second service provider may have a second hunger score. The second hunger score may be higher than the first hunger score. Although a spend target is specifically mentioned, other factors may be used to determine the hunger score for a particular service provider.

Accordingly, although not required, the service provider's connect score 163 may fluctuate over a given time period based on their hunger score. In some embodiments, the connect score 163 may not vary based on the hunger score. However, the hunger score may have an effect on the probability that the consumer will answer a request.

In addition to the above, and in some embodiments, the connect score 163 may be combined (e.g., added, multiplied and so on) with a random number. The random number may be generated based on instant connect opportunities associated with a service provider and/or have a normal distribution with a mean of 0. For example and in some embodiments, the random number may be more volatile if a service provider has less history with respect to instantly connecting with a potential consumer and less volatile when a service provider has more history with respect to instantly connecting with a potential consumer.

Although a random number is described above, other factors may be added or otherwise combined with the connect score 163. These factors may include time of day of the communication session, month of the year, day of the week and so on.

Combining the connect score 163 with the random number described above may maximize the calculated probability of a service provider accepting an incoming communication. For example, this combination may allow service providers with little or no history to build up a history by artificially inflating or otherwise distorting their connect score 163. In other words, the probability of a particular servicer provider accepting an incoming communication may fall somewhere in a distribution centered around their estimated probability (described above) with a variance that is inversely proportional to their volume of history. As such, service providers without significant history will have a chance to be called in place of service providers who have significant history even if the service provider without the significant history has a lower estimated accept probability.

Once the connect score 163 has been calculated using the above, the service providers that have a connect score 163 over a particular threshold may be determined or otherwise selected as potential service providers for an instant connect session with the consumer.

In some implementations, the connect score 163 may be automatically tracked and updated by the communication module 180. For example, the communication module 180 may track whether the various service providers accept the leads they are given. This information may be used to update the connect scores 163 of the various service providers.

For service providers that are new to the system 100 and who may not have a connect score 163 (or for service providers who have a connect score 163 below a threshold), the communication module 180 may randomly select one or more of these service providers from the database and include them in the identified subset of service providers (presuming they meet other criteria such as skills 161 and geographic location 162). Thus, service providers that are newer to the system 100 may have the opportunity to be instantly connected with a consumer.

In addition, the communication module 180 may place these service providers in random position in the calling pool (e.g., the subset of service providers whose connect score 163 makes them eligible for leads) regardless of their connect score 163 such as described above. That is, a service provider that is new to the system 100 or that may have a low connect score 163 may be placed in the calling pool hierarchy (e.g., the order of service providers based on their connect score 163) above a service provider with a higher connect score 163. Thus, the new service provider may be given opportunities to raise his connect score 163.

In some embodiments, the communication module 180 may track the number of times the new service provider has been given opportunities to be instantly connected with a requesting consumer. The more the new service provider accepts leads, the more opportunities the new service provider may be given (at least until his connect score 163 exceeds a minimum connect score 163 threshold). However, if the new service provider has not increased his connect score 163 above the connect score threshold within a given number of opportunities, the communication module 180 may cease to place, or decrease placement of, that particular service provider in the calling pool. As such, the new service provider may be given fewer opportunities to raise his score.

Likewise, the communication module 180 may track the number of times a particular service provider has been pushed down in the ranking due to the new service provider being given the opportunities discussed above. That way, one service provider with a high connect score 163 will not be continually denied the opportunity to accept or deny leads by constantly being displaced by new service providers. For example, if a service provider with a high connect score 163 has moved down the calling pool hierarchy due to a new service provider being placed ahead of him, that particular service provider will not be displaced by another new service provider for a period of time.

In other implementations, the communication module 180 may identify two or more service providers with high connect scores 163 or connect scores 163 that are above a threshold. Once these service providers are identified, the communication module 180 may generate and send an automated message to each service provider simultaneously or substantially simultaneously. The first service provider to accept the lead may then be given the opportunity to instantly connect with the consumer.

In another implementation, the communication module 180 may allow each of the service providers to accept or reject the lead. If multiple service providers respond (e.g., respond within a threshold amount of time), the communication module 180 may generate an automated message that includes information about each service provider. This automated message may be provided to the consumer. When the automated message is received or otherwise acknowledged by the consumer, the consumer is given the opportunity to instantly connect with one of the service providers. Additionally or alternatively, upon receipt or acknowledgement of the automated message the consumer may instantly connect with each of the identified service providers.

In this particular example, the communication module 180 may instantly connect the consumer with each service provider in a determined sequence (e.g., based on the response time of each service provider). In some implementations, the consumer may be given an option to instantly connect with the additional service providers after a communication session with one of the service providers has ended.

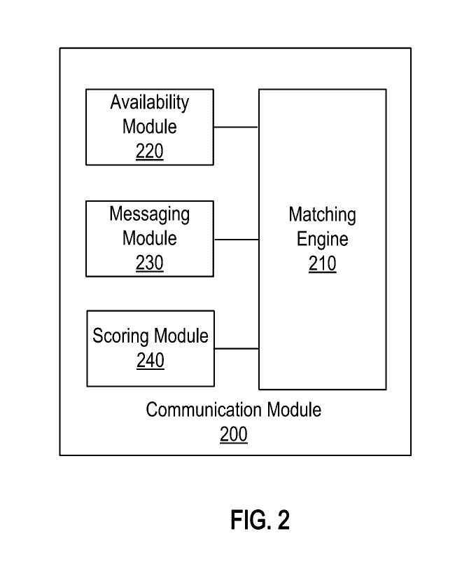

FIG. 2 illustrates example components or modules of a communication module 200 that may be used to facilitate one or more communication sessions between consumers and service providers according to one or more embodiments of the present disclosure. The communication module 200 may be similar to communication module 180 described above with respect to FIG. 1. Thus, the communication module 180 may include the various modules and components described below.

In some embodiments, the communication module 200 may include a matching engine 210. The matching engine 210 may take information provided by a consumer and find an appropriate service provider match. For example, the consumer may provide information about a project, product or service in an electronic form or other electronic medium and provide that information to the matching engine 210. The matching engine 210 may parse the information provided by the consumer and store it in a database. The matching engine 210 will then match the received information with information provided by the various service providers.

As discussed above, the information may include the type of products or services requested or desired by the consumer, a geographic location in which the product or service will be performed or provided, time and/or budget constraints of the project, product or service and the like.

In some embodiments, the communication module 200 also includes an availability module 220. The availability module 220 may communicate with the matching engine 210 in order to determine which service providers should be included in the subset of service providers.

For example, the availability module 220 may have access to one or more calendaring applications associated with or used by the various service providers. Thus, the matching engine 210, via the availability module 220, may be able to check the availability of each service provider when determining whether to include the service provider in the subset of service providers. Further, the matching engine 210 may (optionally) rank or otherwise scale the connect score of the service provider in the subset based on their determined availability. Thus, if a service provider is not available, their connect score may be scaled accordingly. In some cases, the scaling of the service provider's connect score may cause that particular service provider to not be included in the subset. However, because the service provider was unavailable, the service provider's connect score may not be adversely affected as that service provider would have not been able to accept a lead should the opportunity have arisen.

Put another way, if a service provider meets the geographic location criteria and the skill set criteria of an inquiry from the consumer but has no availability during the requested timeframe, the matching engine 210 may not include that service provider in the subset. Thus, although the service provider potentially missed out on a lead (one that he could not have accepted anyway due to his lack of availability), his connect score remains unchanged.

In some implementations, the availability module 220 may also be configured to update the calendaring application of the service provider and/or the consumer. Thus, when a lead or job has been accepted or otherwise agreed to by the parties, the availability module 220 may update the calendaring application of the service provider to show the details of the project. For example, the availability module 220 may update the calendaring application to include the date, time and location of the accepted project.

The communication module 200 may also include a messaging module 230. As with the availability module 220, the messaging module 230 may be in communication with the matching engine 210. In some embodiments, the messaging module 230 may be configured to generate automated messages that are provided to the subset of service providers. For example, the messaging module 230 may receive information provided by the consumer and use that information when the automated message is generated.

Once the automated message has been automatically generated by the messaging module 230, the automated message is transmitted, via the communication module 200, to the service provider.

In another embodiment, once the automated message has been generated by the messaging module 230, the communication module 200 may send out the automated message to multiple service providers simultaneously or substantially simultaneously. In such instances, the service provider that answers the automated message or otherwise accepts the lead first will be instantly connected to the consumer via the communication module 200.

The communication module 200 may also include a scoring module 240. The scoring module 240 may be in communication with the matching engine 210. In some embodiments, the scoring module 240 tracks whether a service provider accepts or denies a potential lead (e.g., instantly connects with a consumer). Accordingly, the scoring module 240 may use a scoring algorithm to dynamically update a connect score of each service provider. As the score is dynamically updated, the matching engine 210 may consider the updated score when generating the subset of service providers.

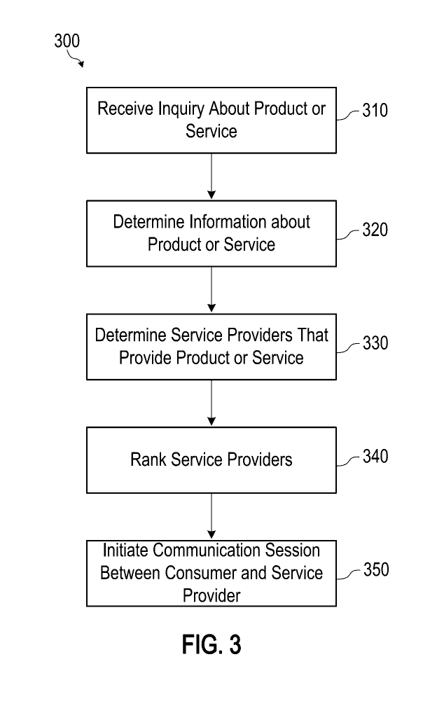

FIG. 3 illustrates a method 300 for facilitating communication sessions between consumers and service providers according to one or more embodiments of the present disclosure. The method 300 may be used by the system 100 described above with respect to FIG. 1.

Method 300 begins at operation 310 in which an inquiry about a particular product or service is received from a consumer. In some embodiments, the consumer may access a website or a webpage and provide information about the desired product or service. For example, the consumer may access an electronic form, text box, radio button, or other selection mechanism provided on the website and provide information about a desired project, product or service. In another embodiment, the consumer may speak, type, input or otherwise use an application executing on a mobile computing device, or other such computing device, to provide the information about the desired product or service.

The consumer may also provide personal information about the consumer including geographic location, contact information and the like. In some embodiments, the contact information and/or geographic location may be determined automatically using, for example, an IP address associated with the computing device of the consumer, one or more GPS sensors included in a mobile computing device of the consumer and so on.

Once this information has been provided, flow proceeds to operation 320 in which specific information about the product or service is parsed and identified so that information may be used to match the consumer with one or more potential service providers. For example, the information provided by the consumer may be parsed by a matching engine to obtain geographic location information of the consumer, desired materials, desired products or product brands, the skill set or skill sets required to provide the desired product or service, the desired timeframe, the desired cost and the like.

Once this information is obtained, flow proceeds to operation 330 and service providers are identified. The service providers are identified based, at least in part, on information that the service providers have provided to the system. For example, service providers that have the required skill set or skill sets and that service the geographic location of the consumer are identified.

The identified service providers are then ranked 340 according to a scoring algorithm. For example and as discussed above, the scoring algorithm may take into account the historical acceptance of leads by each service provider. That is, the scoring algorithm may rank the service providers based on the number of times the service providers were offered a lead, accepted the lead, listened to or otherwise accepted or acknowledged an automated message and/or instantly connected with the consumer.

In some embodiments, the various factors may be weighted. In other embodiments, the score of each service provider may be weighted on other factors. In one example, the score of a service provider may be weighted based on availability of the service provider. Thus, if the service provider is not available during the timeframe requested by the consumer, the service provider may still be given the option to instantly connect with the consumer (although the service provider may be placed lower on the calling hierarchy). However, as described above, although the ranking of the service provider may be lowered, the service provider's connect score would not be affected as he had limited or no availability to accept the lead.

Flow then proceeds to operation 350 in which a communication session is initiated between the highest ranked service provider and the consumer. As discussed above, a communication module may generate an automated message and provide that automated message to the highest ranked service provider.

Once the automated message is received, the highest ranked service provider can choose to deny the lead or instantly connect with the consumer. If the service provider chooses to accept the lead, the communication module establishes a communication session between the service provider and the consumer. In embodiments where a second automated message is used, the communication module generates the second automated message and sends it to the consumer as discussed above. If the consumer chooses to instantly connect with the service provider, the communication module establishes a communication session between the parties.

If the highest ranked service provider is unavailable or does not accept the lead or if the consumer does not answer the automated message or want to instantly connect with the service provider, the automated message is sent to the service provider with the next highest connect score and the process repeats.

Although the embodiments described above describe that an automated message is provided to the consumer, this is not required. For example, once a service provider accepts the lead, the communication module may initiate a communication session between the parties without sending an automated message to the consumer.

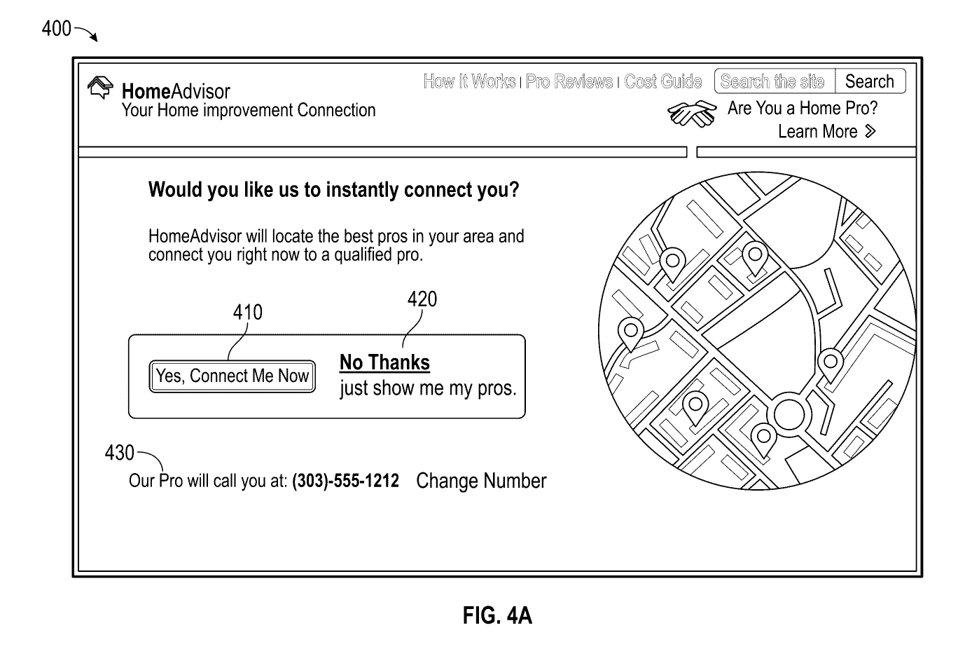

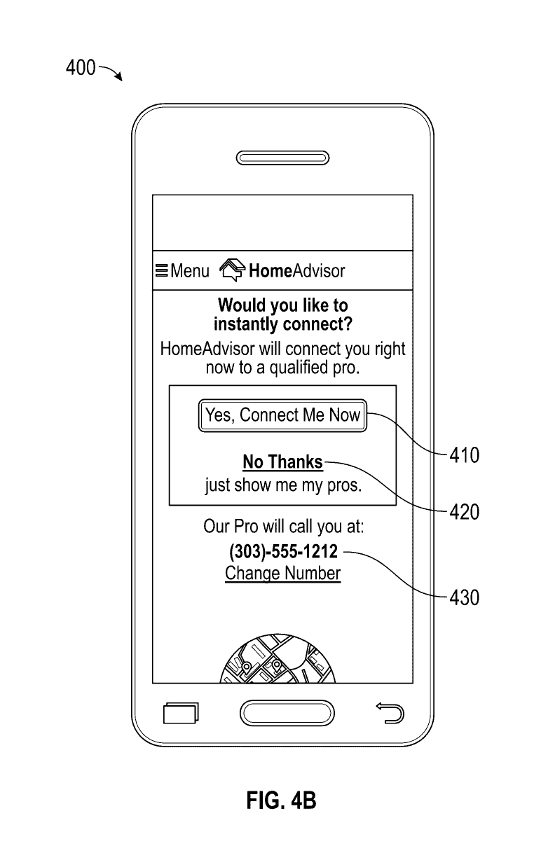

FIGS. 4A-7B illustrate a series of example user-interfaces that may be used to facilitate one or more communication sessions between consumers and service providers according to one or more embodiments of the present disclosure. The user-interfaces shown with respect to these figures may be provided on a number of different computing devices. For example, each user-interface may be provided on a web browser of a computing device, such as, for example, a desktop computer, a laptop computer, a tablet computing device and the like. In other implementations, each user-interface may be provided on a mobile computing device. For example, the user-interface may be a user-interface of a mobile application.

FIG. 4A illustrates an example user-interface 400 that facilitates a communication session between a consumer and a home service provider. FIG. 4B illustrates a similar user-interface 400 that is output on a portable computing device. As the user-interface 400 shown in each of FIGS. 4A-4B may be similar, like reference numbers are used for both figures.

The user-interface 400 may be used to provide a consumer an ability to choose or otherwise opt into a communication session with a service provider. More specifically, the user-interface 400 may be used to instantly connect a consumer with a home service provider in the manner described above. For example, the user-interface 400 may be provided to a consumer who accesses a system for facilitating communications sessions between consumers and home service providers, such as, for example, system 100 shown and described with respect to FIG. 1.

More specifically, once a consumer has provided information about the desired project, their contact information and so on, the system may provide the user-interface 400 to the consumer. The user-interface 400 may include a first soft-button 410, or other such selection mechanism, that enables a consumer to instantly connect with one or more service providers that have been identified, or will be identified, using the various methods described above. For example and as shown in FIGS. 4A-4B, the user-interface 400 provides a soft-button 410 labeled “Yes, Connect Me Now”.

The user-interface 400 may also provide a second soft button 420 that enables the consumer to opt out of or otherwise decline the option to instantly connect with a home service provider. The user-interface 400 also includes contact information 430 of the consumer. The contact information 430 may be used to indicate how the identified home service provider will be contacting the consumer should the consumer want to be instantly connected with the home service provider. The user-interface 400 may also provide the user with an option to change their contact information and/or their preferred method of contact (e.g., phone call, text message, email and so on).

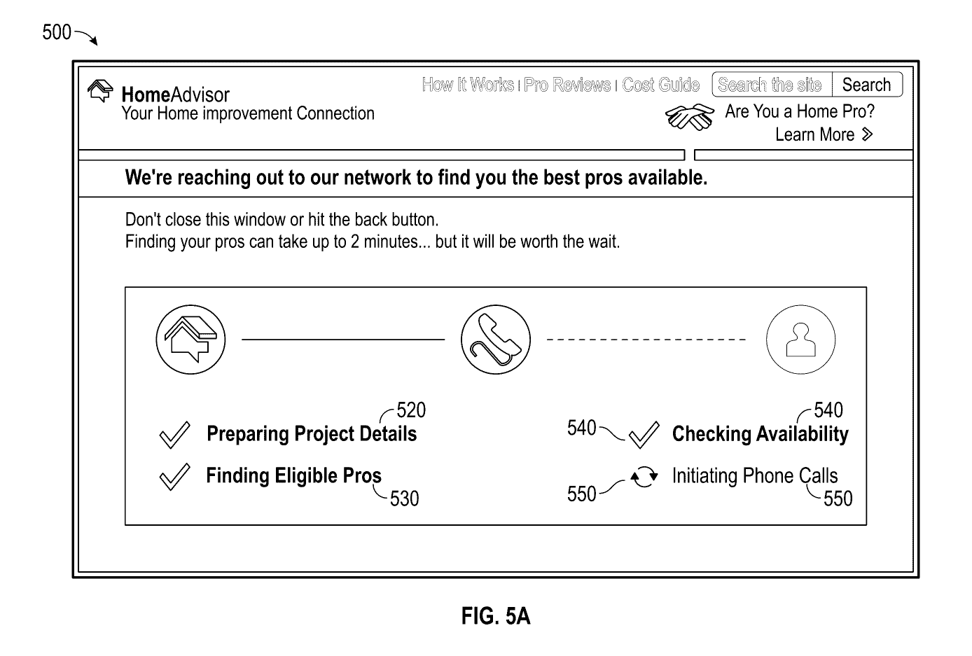

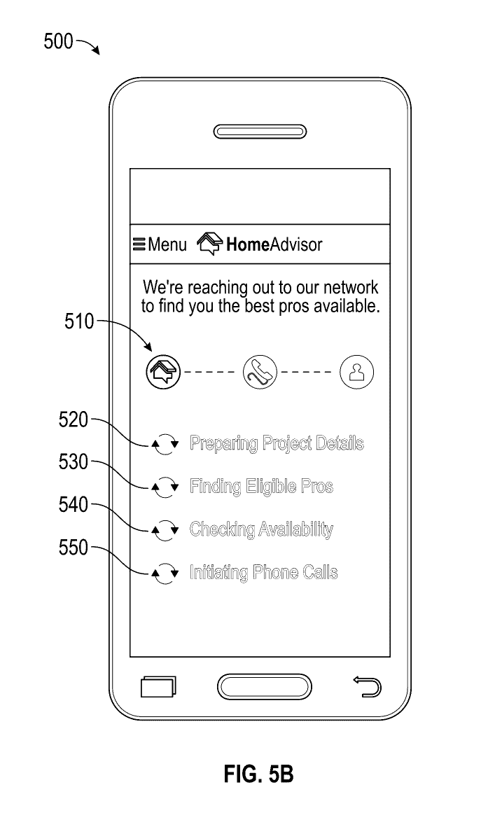

Should the consumer select soft button 410, a second user-interface 500 (shown in FIGS. 5A-5B) will be provided to the consumer. The second user-interface 500 may be referred to as a connecting page. More specifically, the second user-interface 500 may include information 510 about the progress of connecting the consumer with a home service provider.

For example, the user-interface 500 may include a first status indicator 520 that shows the status of preparing or otherwise identifying the details about the project the consumer is interested in. The information 510 may also include a second status indicator 530 that shows the status of identifying eligible home service providers. The information 510 may also include a third status indicator 540 that shows the status of checking the availability of the home service providers. A fourth status indicator 550 that shows the status of how the system is contacting the home service providers may also be provided.

Each of the status indicators may be dynamically updated to show the progress of instantly connecting the consumer with a home service provider. As such, each of the indicators may be color coded or include some other type of indicator that provides this information to the consumer.

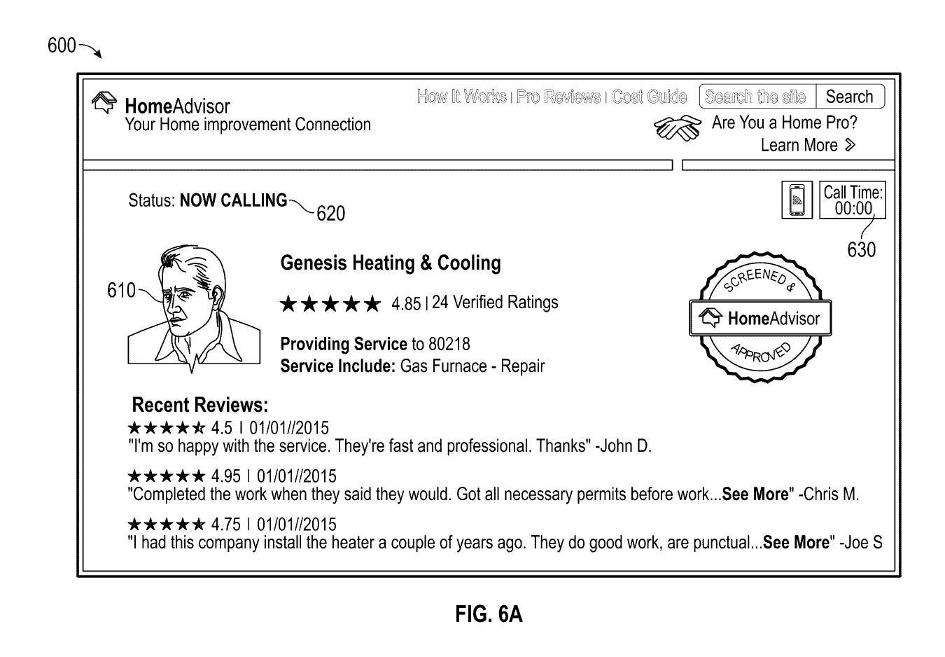

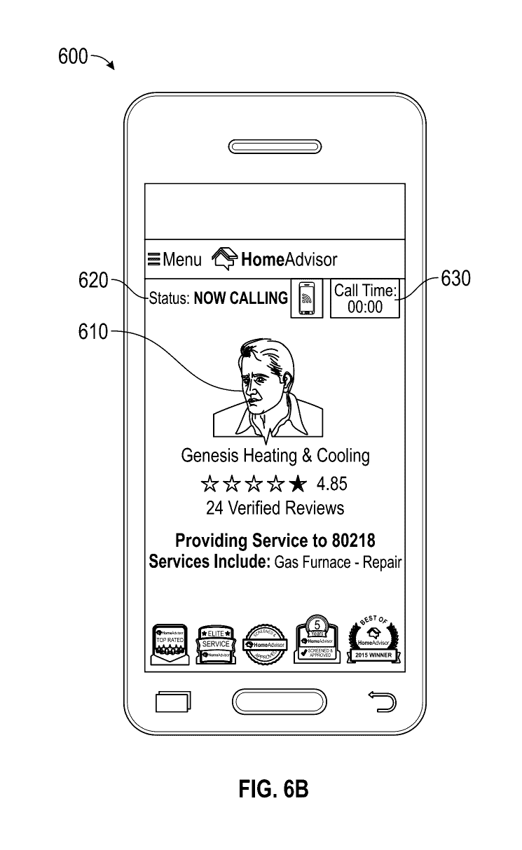

FIG. 6A illustrates a third example user-interface 600 that may be used to facilitate one or more communications sessions between consumers and service providers and FIG. 6B illustrates the example user-interface 600 provided on a portable computing device according to one or more embodiments of the present disclosure. The user-interface 600 may be provided to the consumer during or after the system has identified and/or contacted the identified home service provider.

The user-interface 600 may include information 610 about the identified home service provider. This information 610 may include the name of the home service provider, the company of the home service provider, reviews of the home service provider and other such information.

The user-interface 600 may also provide a status indicator 620 that shows the status of the communication session. The user-interface 600 may also include a timer 630 that shows the amount of time of the communication session.

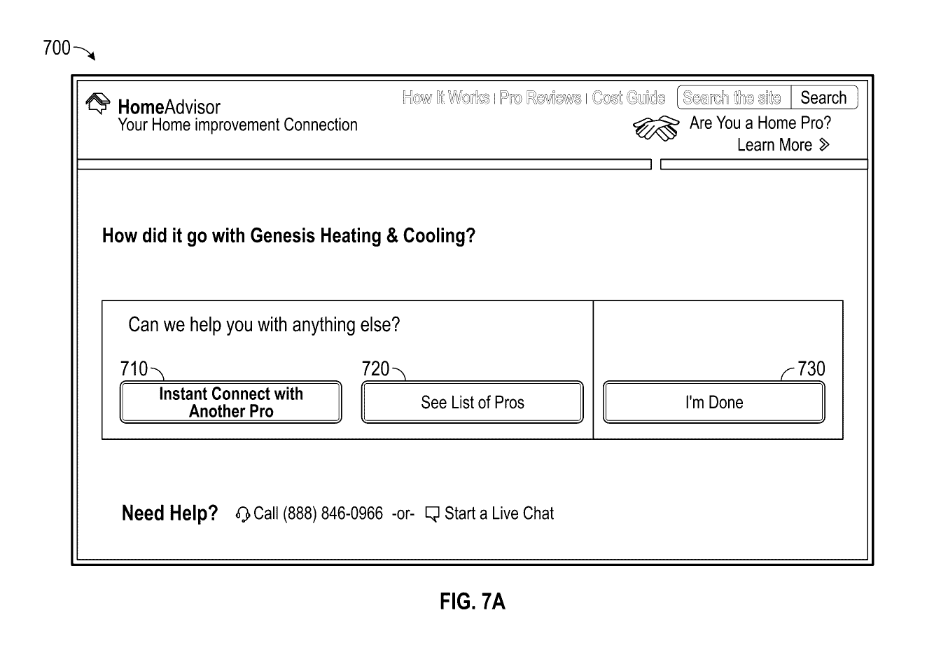

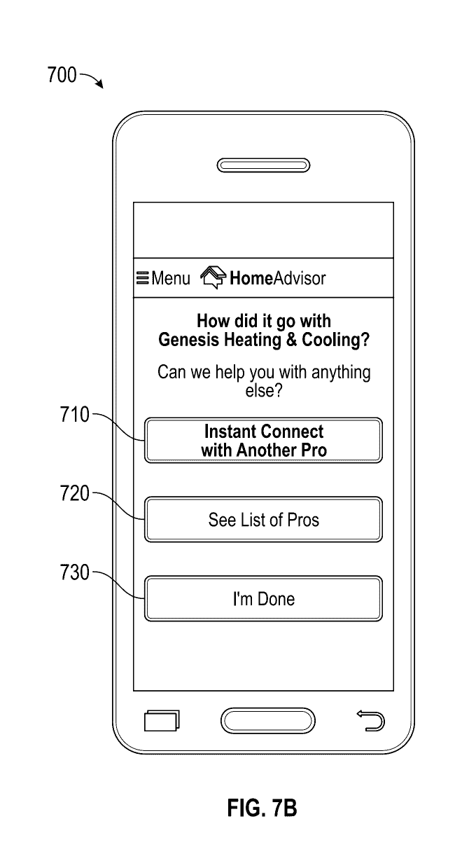

Once the communication session between the identified home service provider and the consumer has ended, a fourth user-interface 700 (shown in FIGS. 7A-7B) may be provided to the consumer. The fourth user-interface 700 may include a first soft button 710 that enables a consumer to be instantly connected with another home service provider, a second soft button 720 to see a list of some or all of the identified home service providers and/or a third soft button 730 that ends the session.

In some embodiments, selection of the first soft button 710 may cause the consumer to be connected with the home service provider that has the second highest connect score such as described above. Selection of the second soft button 720 may cause a list of home service providers with the top 5 connect scores to be provided on a user-interface.

Although specific examples have been shown and described, it is appreciated that these are examples only. As such, various user-interfaces may be generated and each user-interface may provide various items of information that describe that status of a communication session between a consumer and a home service provider.

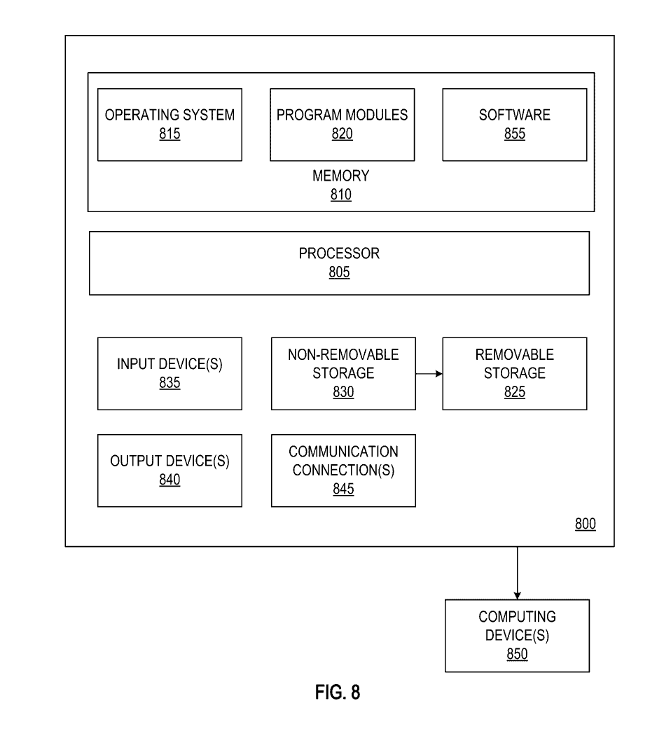

FIG. 8 is a block diagram illustrating exemplary components, such as, for example, hardware components of a computing device 800 according to one or more embodiments of the present disclosure. In certain embodiments, the computing device 800 may be similar to the computing devices used by the various consumers and service providers described above. Further, the computing device 800 may be similar to the server 150 shown and described with respect to FIG. 1. Although various components of the computing device 800 are shown, connections and communication channels between each of the components are omitted for simplicity.

In a basic configuration, the computing device 800 may include at least one processor 805 and an associated memory 810. The memory 810 may include, but is not limited to, volatile storage such as random access memory, non-volatile storage such as read-only memory, flash memory, or any combination thereof. The memory 810 may store an operating system 815 and one or more program modules 820 suitable for running software applications 855. The operating system 815 may be configured to control the computing device 800 and/or one or more software applications 855 being executed by the operating system 815.

The computing device 800 may have additional features or functionality than those expressly described herein. For example, the computing device 800 may also include additional data storage devices, removable and non-removable, such as, for example, magnetic disks, optical disks, or tape. Exemplary storage devices are illustrated in FIG. 8 by removable storage device 825 and a non-removable storage device 830.

In certain embodiments, various program modules and data files may be stored in the system memory 810. The program modules 820 and the processor 805 may perform processes that include one or more of the operations of method 300.

As also shown in FIG. 8, the computing device 800 may include one or more input devices 835. The input devices 835 may include a keyboard, a mouse, a pen or stylus, a sound input device, a touch input device, and the like. The computing device 800 may also include one or more output devices 840. The output devices 840 may include a display, one or more speakers, a printer, and the like.

The computing device 800 also includes communication connections 845 that facilitate communications with additional computing devices 850. Such communication connections 845 may include internet capabilities, a RF transmitter, a receiver, and/or transceiver circuitry, universal serial bus (USB) communications, parallel ports and/or serial ports.

As used herein, the term computer-readable media may include computer storage media. Computer storage media may include volatile and nonvolatile media and/or removable and non-removable media for the storage of information. Examples include computer-readable instructions, data structures, and program modules. The memory 810, the removable storage device 825, and the non-removable storage device 830 are all examples of computer storage media. Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 800. Any such computer storage media may be part of the computing device 800.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of the specific embodiments described herein are presented for purposes of illustration and description. They are not targeted to be exhaustive or to limit the embodiments to the precise forms disclosed. It will be apparent to one of ordinary skill in the art that many modifications and variations are possible in view of the above teachings.

1. A method for facilitating a communication session between a consumer and a service provider, comprising:
receiving, at a remote computing device, an inquiry about service from a consumer, the inquiry originating from a computing device connected to a network;
obtaining from the inquiry, one or more items of information about the service;
determining, at the remote computing device and based on the one or more items of information, a plurality of service providers that can perform the service;
determining, by the remote computing device using a scoring algorithm, a subset of service providers from the plurality of service providers;
ranking, by the remote computing device, the subset of service providers using the scoring algorithm;
identifying, by the remote computing device, a service provider from the subset of service providers based, at least in part, on the ranking;
determining, by the remote computing device, whether the service provider is currently available for a communication session;
providing, by the remote computing device, a notification that the service provider has been identified and is currently available for the communication session, the notification being transmitted to the computing device and including a selectable element that enables the consumer to be instantly connected with the identified service provider via a communication session; and
automatically initiating the communication session between the identified service provider and the consumer when the selectable element is selected.

2. The method of claim 1, wherein the scoring algorithm comprises a probability that the identified service provider will accept the communication session.

3. The method of claim 1, wherein the scoring algorithm includes information about an availability of each service provider in the subset of service providers.

4. The method of claim 1, further comprising updating a calendar of the identified service provider in response to initiating the communication session.

5. The method of claim 1, further comprising identifying another service provider in the subset of service providers when the communication session between the identified service provider and the consumer cannot be established.

6. The method of claim 1, wherein the communication session is a telephone call.

7. The method of claim 1, wherein the communication session is an electronic message.

8. The method of claim 1, wherein automatically initiating the communication session between the identified service provider and the consumer comprises providing an automated message to the identified service provider, the automated message comprising the one or more items of information about the service.

9. The method of claim 8, further comprising receiving, at the remote computing device, a response to the automated message from the identified service provider.

10. The method of claim 9, further comprising adjusting a score associated with the identified service provider based, at least in part, on the response to the automated message.

11. The method of claim 9, further comprising sending the automated message to another service provider in the subset of service providers when the identified service provider declines the automated message.

12. A system comprising:
at least one processor; and
a memory coupled to the processor, the memory for storing instructions which, when executed by the at least one processor, performs a method for facilitating communications between a consumer and a service provider, comprising:
receiving, from a remote device associated with a consumer, a response to a service request form;
parsing the response to determine one or more items of information about a home project identified in the service request form;
identifying a plurality of service providers from a database of service providers based, at least in part, on information provided by the service providers and on the information about the home project;
ranking the plurality of service providers based, at least in part, on a scoring algorithm;
determining which service providers in the plurality of service providers are currently available to be instantly connected to the consumer; and
providing an opportunity for each currently available service provider to be instantly connected to the consumer, via the communication session, the opportunity being transmitted for display on the remote device.

13. The system of claim 12, further comprising a communication module for establishing the communication session.

14. The system of claim 13, wherein the communication module facilitates a telephone communication between at least one service provider in the plurality of service providers and the consumer.

15. The system of claim 13, wherein the communication module facilitates an electronic communication between at least one service provider in the plurality of service providers and the consumer.

16. The system of claim 12, wherein the scoring algorithm comprises a number of times at least one service provider of the plurality of service providers has accepted a previously offered communication session.

17. The system of claim 12, wherein the service request form is integrated within a webpage accessible by the remote device.

18. A non-transitory computer-readable storage medium encoding computer readable instructions which, when executed by a processor, performs a method for facilitating a communication session between a consumer and a service provider, comprising:
receiving, from a computing device associated with the consumer, an electronic inquiry about a product or service;
obtaining from the inquiry, one or more items of information about the product or service;
determining, based on the one or more items of information, a plurality of service providers that can provide the product or service;
determining a subset of service providers from the plurality of service providers, based at least in part, on a historical acceptance of one or more solicited communication sessions;
ranking the subset of service provider based, at least in part, on the historical acceptance the one or more solicited communication sessions;
determining whether a highest ranked service provider is currently available for a communication session with the consumer; and
when it is determined that the highest ranked service provider is currently available for the communication session, automatically providing an automated message to a computing device associated with the highest ranked service provider, the automated message including a selectable element that enable the highest ranked service provider to be instantly connected with the consumer via the communication session.

19. (canceled)

20. The non-transitory computer-readable storage medium of claim 18, further comprising instructions for selecting a service provider from the plurality service providers that has had less than a threshold amount of solicited communication sessions.

21. The non-transitory computer-readable storage medium of claim 18, further comprising instructions for selecting a next highest ranked service provider when it is determined the highest ranked service provider is not currently available.
